(19) United States
(12) Patent Application Publication
(10) Pub. No.: US 2021/0339438 A1
(43) Pub. Date: Nov. 4, 2021

(54) APPARATUS AND METHOD FOR FORMING MOLDED PRODUCTS

(71) Applicants: Derek Hodges, Sebring, FL (US); Eric Bowman, Atlanta, IN (US)

(72) Inventors: Derek Hodges, Sebring, FL (US); Eric Bowman, Atlanta, IN (US)

(21) Appl. No.: 17/376,703

(22) Filed: Jul. 15, 2021

Related U.S. Application Data
(63) Continuation of application No. 17/231,042, filed on Apr. 15, 2021.
(60) Provisional application No. 63/011,380, filed on Apr. 17, 2020.

(51) Int. Cl. B29C 43/36; B29C 43/04

(52) U.S. Cl. CPC B29C 43/36; B29C 43/04

(57) ABSTRACT

A press apparatus for forming molded products is provided and includes an motive source and a press assembly in fluid communication with the motive source. The press assembly includes a press plate and a device configured to actuate axial movement of the press plate as initiated by the motive source. A mold base is positioned within the press assembly and configured for engagement with the press plate. The mold base includes a plurality of mold cavities and each of the mold cavities includes a mold cavity aperture. Each of the mold cavity apertures is arranged in a pattern and configured to provide access to a molded product positioned in a mold cavity. A release assembly is configured for engagement with the mold base and has a plurality of release fingers, each extending from a base plate. The plurality of release fingers is arranged in a pattern that aligns with the pattern of the mold cavity apertures.

### RELATED APPLICATIONS

This application is a continuation of pending U.S. Utility patent application Ser. No. 17/231,042, filed Apr. 15, 2021, which claims the benefit of Provisional Patent Application No. 63/011380, filed Apr. 17, 2020, the disclosures of which are incorporated herein by reference in their entirety.

### BACKGROUND

Molded products include the non-limiting examples of soaps, candles, chocolates, cosmetics and the like. In certain instances, molded products can be formed using a mold. The mold typical forms a cavity into which is placed a moldable mixture. The moldable mixture is allowed to cure, and the formed molded product is removed from the mold

However, conventional molds and molding methods are known to be slow, difficult to manage, require a limited quantity of formed products to be formed at one time, require large molding fixtures, require large power supplies and can be messy requiring extensive clean-up labor.

It would be advantageous if apparatus and methods for forming molded products could be improved.

### SUMMARY

It should be appreciated that this Summary is provided to introduce a selection of concepts in a simplified form, the concepts being further described below in the Detailed Description. This Summary is not intended to identify key features or essential features of this disclosure, nor it is intended to limit the scope of the apparatus and method for forming molded products.

The above objects as well as other objects not specifically enumerated are achieved by a press apparatus for forming molded products. The press apparatus includes a motive source and a press assembly in fluid communication with the motive source. The press assembly includes a press plate configured for axial movement and a device configured to actuate axial movement of the press plate as initiated by the motive source. A mold base is positioned within the press assembly and configured for engagement with the press plate. The mold base includes a plurality of mold cavities and each of the mold cavities includes a mold cavity aperture. Each of the mold cavity apertures is arranged in a pattern and configured to provide access to a molded product positioned in a mold cavity. A release assembly is configured for engagement with the mold base and has a plurality of release fingers, each extending from a base plate. The plurality of release fingers is arranged in a pattern that aligns with the pattern of the mold cavity apertures.

The above objects as well as other objects not specifically enumerated are also achieved by a method of using a press apparatus for forming molded products. The method includes the steps of providing fluid communication between a motive source and a press assembly, the press assembly including a press plate configured for axial movement and a device configured to actuate axial movement of the press plate, positioning a mold base within the press assembly in a manner such that the press plate aligns with the mold base, actuating axial movement of the press plate and engaging the mold base, the mold base including a plurality of mold cavities, compressing a moldable mixture positioned within a plurality of the mold cavities, thereby forming a plurality of molded products, inverting the mold base and repositioning the inverted mold base within the press assembly and aligning with the press plate, engaging the inverted mold base with a release assembly, thereby releasing the molded products from the mold base.

Various objects and advantages of the apparatus and method for forming molded products will become apparent to those skilled in the art from the following Detailed Description, when read in light of the accompanying drawings.

### BRIEF DESCRIPTION OF THE DRAWINGS

FIG. 1 is a schematic perspective illustration of a press apparatus for forming molded products in accordance with the invention.

FIG. 2 is a front view of a press assembly of the press apparatus of FIG. 1.

FIG. 3 is a plan view of the press assembly of FIG. 2.

FIG. 4 is an exploded perspective view of the press assembly of FIG. 2.

FIG. 5 is a perspective view of a support member of the press assembly of FIG. 2.

FIG. 6 is a plan view of the support member of the press assembly of FIG. 2.

FIG. 7 is a perspective view of a mold base of the press apparatus of FIG. 1.

FIG. 8 is a plan view of the mold base of FIG. 7.

FIG. 9 is a perspective rear view of the mold base of FIG. 7.

FIG. 10 is a rear view of the mold base of FIG. 7.

FIG. 11 is a cutaway side view of a mold cavity of the mold base of FIG. 7.

FIG. 12 is a schematic illustration of a method of using the press apparatus of FIG. 1.

FIG. 13 is a perspective view of a release assembly of the press apparatus of FIG. 1.

FIG. 14 is a side view of a release assembly of FIG. 13.

FIG. 15 is a schematic illustration of a method of releasing a molded product from the mold base of FIG. 7.

FIG. 16 is a plan view of a molded product having a first embodiment of an imprint.

FIG. 17 is a plan view of a molded product having a second embodiment of an imprint.

### DETAILED DESCRIPTION

The apparatus and method for forming molded products will now be described with occasional reference to specific embodiments. The apparatus and method for forming molded products may, however, be embodied in different forms and should not be construed as limited to the embodiments set forth herein. Rather, these embodiments are provided so that this disclosure will be thorough and complete, and will fully convey the scope of the apparatus and method for forming molded products to those skilled in the art.

Unless otherwise defined, all technical and scientific terms used herein have the same meaning as commonly understood by one of ordinary skill in the art to which the apparatus and method for forming molded products belongs. The terminology used in the description of the apparatus and method for forming molded products herein is for describing particular embodiments only and is not intended to be limiting of the apparatus and method for forming molded products. As used in the description of the apparatus and method for forming molded products and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the apparatus and method for forming molded products. Notwithstanding that the numerical ranges and parameters setting forth the broad scope of the apparatus and method for forming molded products are approximations, the numerical values set forth in the specific examples are reported as precisely as possible. Any numerical values, however, inherently contain certain errors necessarily resulting from error found in their respective measurements.

An apparatus and method for forming molded products is disclosed. The term “molded product”, as used herein, is defined to mean any item formed from molten, soft, semi-soft or other materials having a formable composition into a desired shape. The apparatus and method include a press assembly configured to engage a mold assembly. The apparatus and method also include a release assembly configured to engage the press assembly in a manner to release cured molded products from the mold assembly.

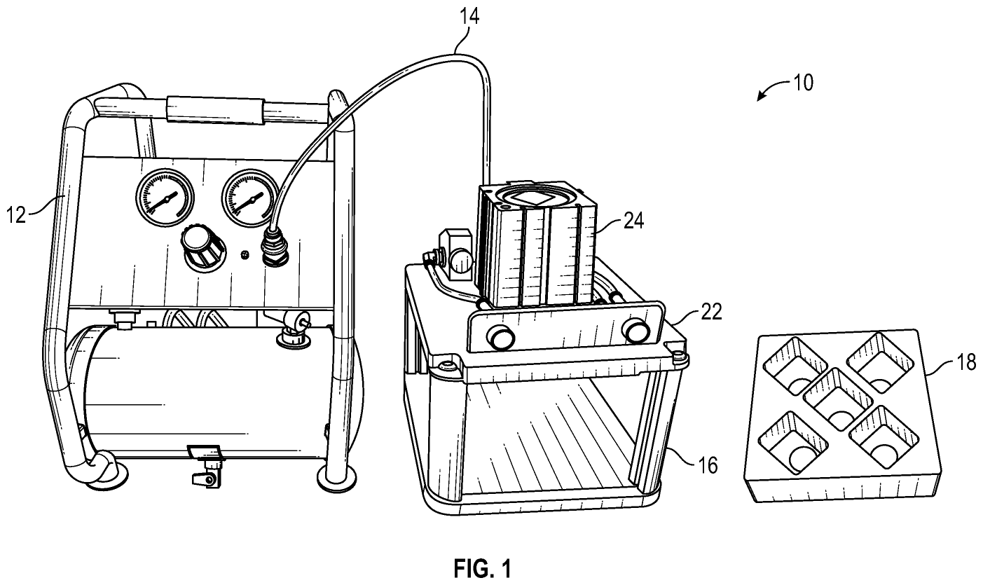

Referring now to FIG. 1, a press apparatus for forming molded products is generally shown at 10. The press apparatus 10 is configured to receive a moldable mixture and shape the moldable mixture, thereby forming molded products. The press apparatus 10 includes a motive source 12, one or more hoses 14, a press assembly 16 and an insertable mold base 18.

Referring again to FIG. 1, the motive source 12 is configured as a source of actuating power to the press assembly 16. In the illustrated embodiment, the motive source 12 has the form of a pneumatic compressor, configured to produce compressed air. The pneumatic compressor is conventional in the art and is configured to delivery compressed air through the one or more hoses 14 to the press assembly 16. However, it should be appreciated that the motive source 12 could have other forms, such as the non-limiting examples of an electrical power source, a hydraulic power source and the like, sufficient to generate an actuating power to the press assembly 16. In the illustrated embodiment, the motive source 12 is a Light and Quiet Portable Air Compressor, model number IP1060SP, marketed and manufactured by California Air Tools Inc., headquartered in San Diego, Calif. However, in other embodiments, other pneumatic compressors can be used. Optionally, the motive source 12 can include a vessel 20 configured to store compressed air, for delivery of compressed air on demand. However, it should be appreciated that the vessel 20 is optional and not required for successful operation of the press assembly.

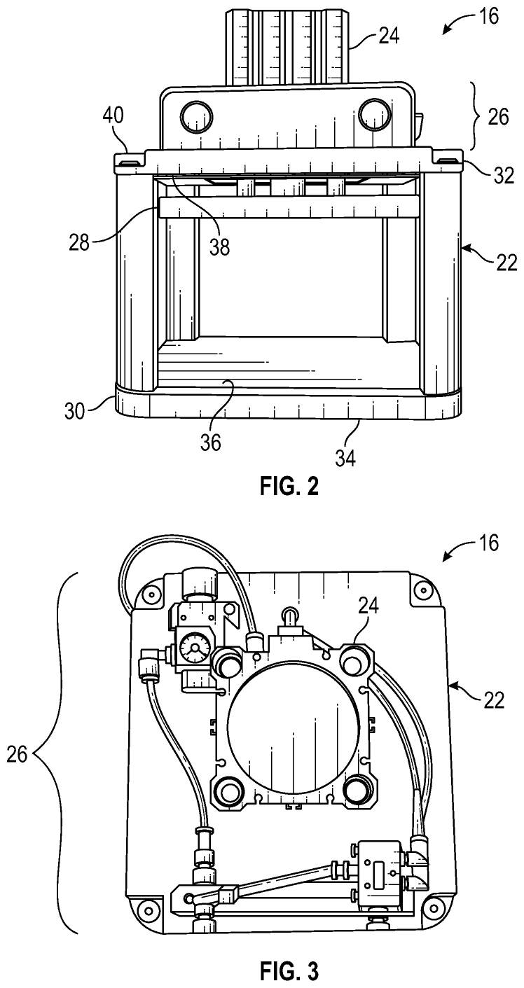

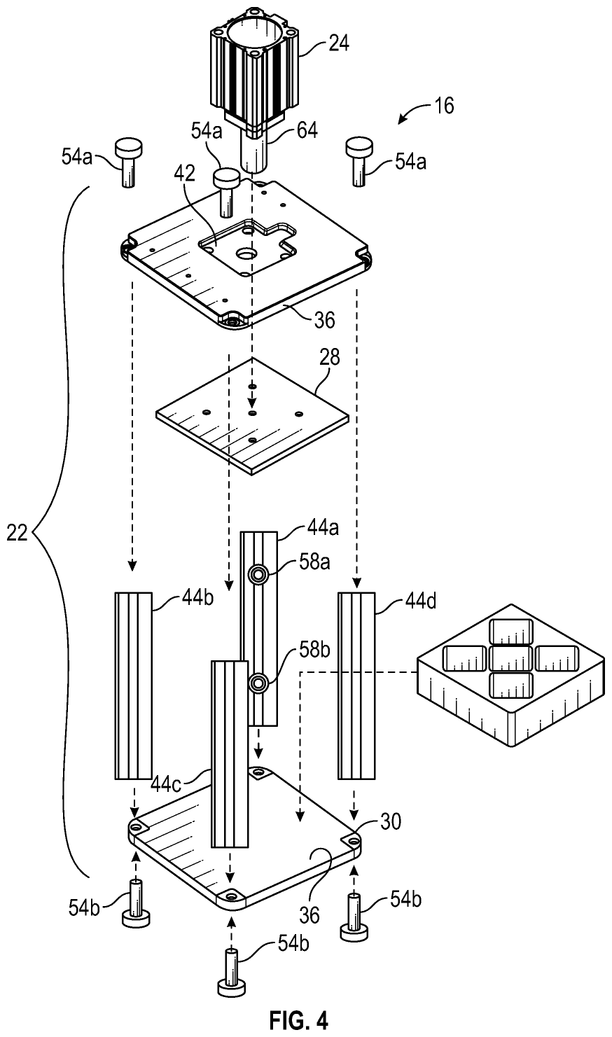

Referring now to FIGS. 2-4, the press assembly 16 is illustrated. The press assembly 16 is configured for several functions. First, the press assembly 16 is configured to receive an actuating power from the motive source 12. Second, the press assembly 16 is configured to convert the actuating power received from the motive source 12 into movement of a press plate 28. Third, the press assembly 16 is configured to generate deliver a compressive force to the moldable mixture through the axial movement of the press plate 28. Finally, the press assembly 16 is configured to release molded products from the mold base 18 through use of a release assembly configured to engage an inverted mold base 18.

Referring again to FIGS. 2-4, the press assembly 16 includes a framework 22, a pneumatic cylinder assembly 24 supported by the framework 22, control equipment 26 in communication with the pneumatic cylinder assembly 24 and a press plate 28 arranged for vertical movement as actuated by the pneumatic cylinder assembly 24.

Referring again to FIG. 2, the framework 22 is configured to support the pneumatic cylinder assembly 24, the control equipment 26 and the press plate 28 and is further configured to support the mold base 18 during forming and releasing operations. The framework 22 includes a base plate 30 and a spaced apart opposing upper plate 32. The base plate 30 includes a bottom face 34 configured for seating on a secure surface. The base plate 30 also includes an opposing top face 36 configured to receive the mold base 18. In the illustrated embodiment, the bottom and top faces 34, 36 are substantially parallel to each other. However, in other embodiments, the bottom and top faces 34, 36 need not be substantially parallel with each other.

Referring again to FIG. 2, the upper plate 32 includes a bottom face 38 arranged in a direction to face the base plate 30. The upper plate 32 also includes an opposing top face 40 configured to receive the pneumatic cylinder assembly 24 and the control equipment 26. In the illustrated embodiment, the top face 40 includes a recessed portion 42, sized and shaped to proximate the cross-sectional shape of the pneumatic cylinder assembly 24, and configured to receive the pneumatic cylinder assembly 24 in a manner such as to prevent rotation of the pneumatic cylinder assembly 24. However, it should be appreciated that in other embodiments, the top face 40 can include other structures, mechanisms and/or devices configured to receive the pneumatic cylinder assembly 24 in a manner such as to prevent rotation of the pneumatic cylinder assembly 24. In the illustrated embodiment, the bottom and top faces 38, 40 are substantially parallel to each other. However, in other embodiments, the bottom and top faces 38, 40 need not be substantially parallel with each other.

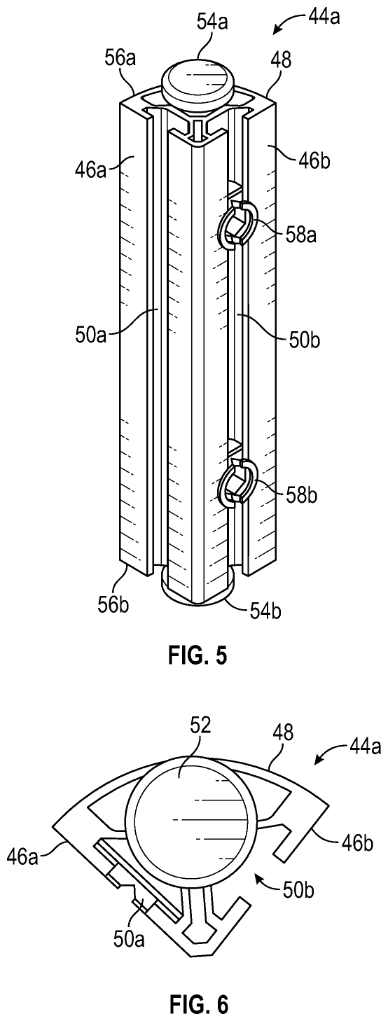

Referring again to FIGS. 2-6, a plurality of support members 44a-44d extend between and connect to the base plate 30 and the upper plate 32. The support member 44a is shown in FIGS. 5 and 6 and is representative of the support members 44b-44d. The support member 44a includes adjacent first and second faces 46a, 46b and a connecting outer face 48. The first and second faces 46a, 46b form substantially flat surfaces and the connecting outer face 48 has an arcuate cross-sectional shape.

Referring again to FIGS. 5 and 6, a first channel 50a is formed in the first face 46a and a second channel 50b is formed in the second face 46b. A bore 52 extends the length of the support member 44a and is configured to receive a top pin 54a at a first end 56a of the support member 44a and a bottom pin 54b at a second end 56b of the support member 44b. The top pin 54a extends within the bore 52 a distance sufficient to engage a first fastener 58a. The top pin 54a and the first fastener 58a form an interactive joint, sufficient such that rotation of the first fastener 58a pulls the top pin 54a toward the first end 56a of the support member 44a, thereby tightening the top pin 54a against the upper plate 32. Further rotation of the first fastener 58a results in tightening of the tip pin 54a against the upper plate 32 and securing of the upper plate 32 against the support member 44a. The upper plate 32 is secured to the remaining support members 44b-44d in a similar fashion.

Referring again to FIGS. 5 and 6, the bottom pins 54b and second fasteners 58b are used in a similar fashion to secure the base plate 40 to the support members 44a-44d. While the embodiment illustrated in FIGS. 5 and 5 illustrate the channels 50a, 50b, the top and bottom pins 54a, 54b and the first and second fasteners 58a, 58b, it should be appreciated that in other embodiments, other structures, mechanisms and devices can be used to secure the base plate 30 and the upper plate 32 to the support members 44a-44d.

Referring now to FIGS. 1-4, the pneumatic cylinder assembly 24 is conventional in the art and is configured to receive an actuating power from the motive source 12. The actuating power from the motive source 12 is converted by the pneumatic cylinder assembly 24 into axial movement of an extending piston rod 64. The piston rod 64 is coupled to the press plate 28 in a manner such that axial movement of the piston rod results in vertical movement of the press plate 28. As will be explained in more detail below, the press plate 28 is configured for engagement with the mold base 18. In the illustrated embodiment, the pneumatic cylinder assembly 24 is a compact guide rod cylinder, model number CQMA80-75, manufactured and marketed by SMC Pneumatics, headquartered in Noblesville, Ind. However, in other embodiments, other structures, mechanisms and devices can be used to engage the press plate 28 with axial movement, including the non-limiting example of an electrically actuated device.

Referring now to FIGS. 2 and 3, the control equipment 26 is configured to control and regulate operation of the pneumatic cylinder assembly 24. The control equipment includes control devices, including the non-limiting examples of on/off switches, pneumatic pressure regulators, pressure releases, pressure gauges and the like. It should be appreciated that in other embodiments, other control regulatory structures, mechanisms and devices can be used.

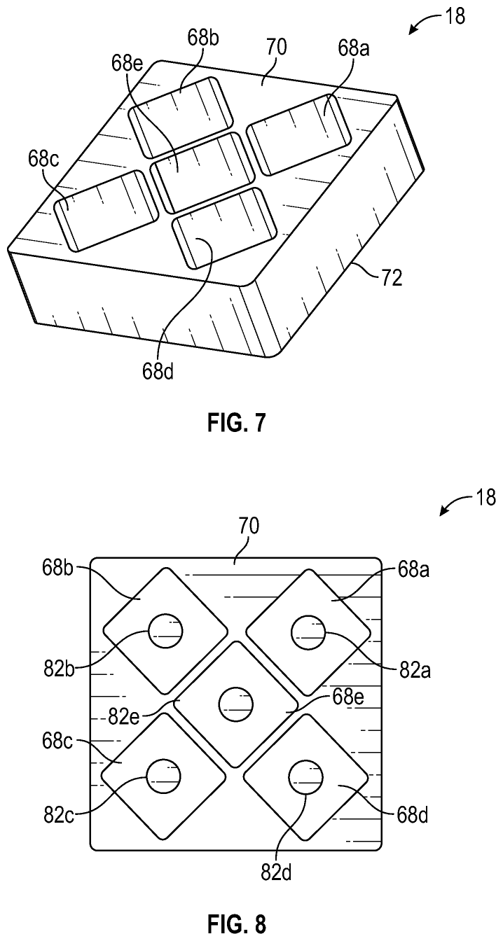

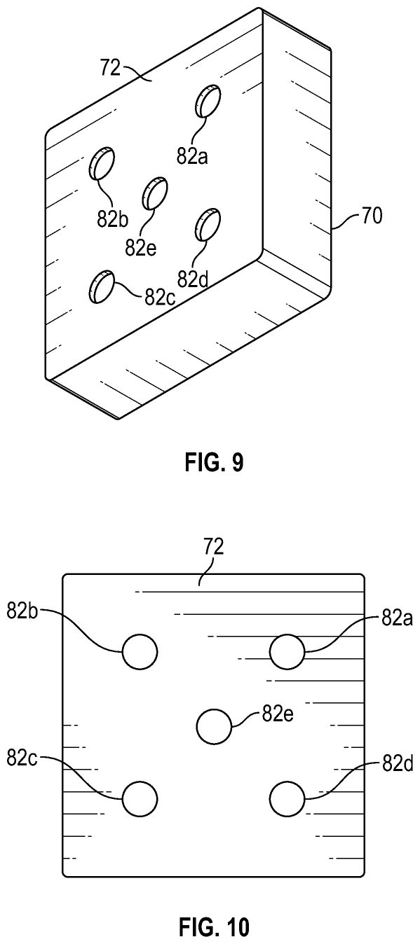

Referring now to FIGS. 7-10, the mold assembly 18 is illustrated. The mold assembly 18 includes a plurality of mold cavities 68a-68e configured for receipt of a moldable mixture. The mold cavities 68a-68e extend from an upper face 70 in a direction toward an opposing lower face 72. During the forming process, the lower face 72 of the mold assembly 18 is configured to seat on the top face 36 of the base plate 30 and the upper face 70 of the mold assembly 18 is configured for engagement with the press plate 28.

In the embodiment illustrated in FIGS. 7-10, the mold assembly 18 includes a quantity of five (5) cavities 68a-68e and is formed from a material configured to release molded products, such as the non-limiting example of a polymeric material. However, in alternate embodiments, the mold assembly 18 can include more or less than five (5) cavities and can be formed from other suitable materials configured to release molded products.

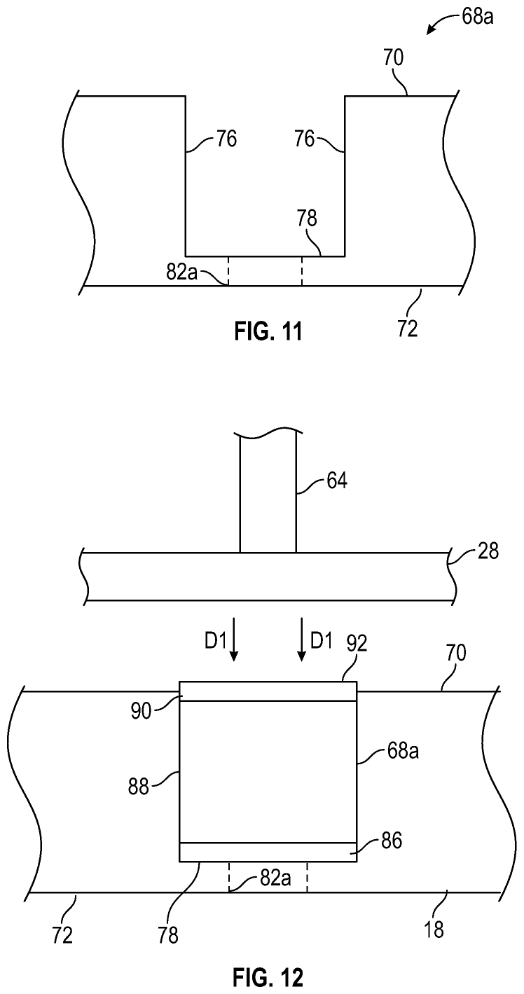

Referring now to FIG. 11, the mold cavity 68a is shown. Mold cavity 68a is representative of the mold cavities 68b-68d. Mold cavity 68a has a cross-sectional configured to defines the shape of the exterior perimeter of a molded product. In the illustrated embodiment, the cross-sectional shape of the mold cavity 68a is of a square, thereby resulting in square exterior perimeter of the molded product. In alternate embodiments, the mold cavities 68a-68e can have other desired cross-sectional shapes thereby forming other desired exterior perimeters of the molded product.

Referring again to FIG. 11, the mold cavity 68a is defined, in part, by cavity side walls 76. The cavity side walls 76 extend from the upper face 70 in a direction toward the lower face 72. However, the cavity side walls 76 stop short of the lower face 72, thereby forming a bottom wall 78.

Referring now to FIGS. 7-11, each of the cavities 68a-68e includes a cavity aperture 82a-82e. Each of the cavity apertures 82a-82e extends from the bottom wall 78 of the mold cavities 68a-68e to the lower face 72 of the mold base 18. As will be discussed in more detail below, the cavity apertures 82a-82e are configured to provide access to the moldable mixture contained in each of the mold cavities 68a-68e during the forming process.

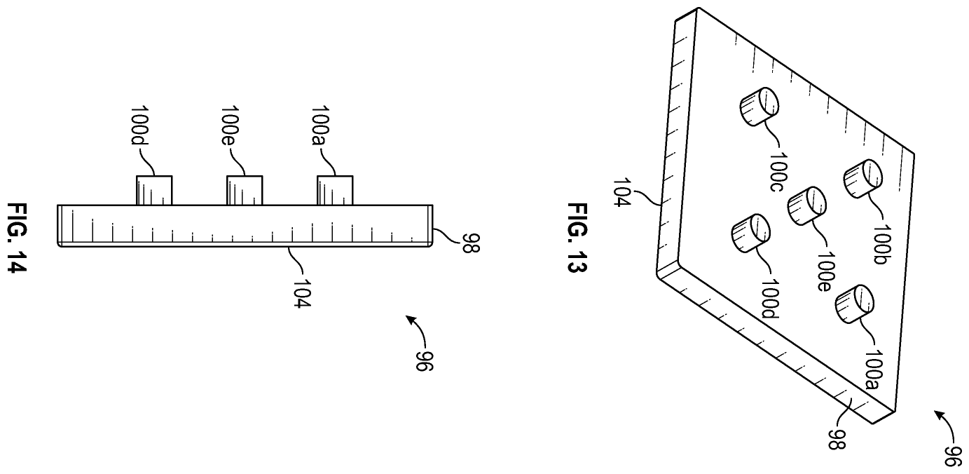

Referring now to FIG. 12, the method of using the press apparatus 10 will now be described using mold cavity 68a. In a first method step, mold cavity 68a of the mold assembly 18 is “loaded”. In this step, a first plug member 86 is seated on the bottom wall 78 of the cavity 68a. The first plug member 86 is configured to prevent a moldable mixture from flowing through the cavity aperture 82a. The first plug member 86 has a cross-sectional shape, generally corresponding to the cross-sectional shape of the cavity 68a.

Referring again to FIG. 12 in a next step, a moldable mixture 88 is inserted into the mold cavity 68a. The moldable mixture 88 seats against an upper surface of the first plug member 86 and against the side walls 76 of the mold cavity 68a. The moldable mixture 88 can have any desired composition, any desired viscosity and can form any desired molded product. Non-limiting examples of molded products include soap, candles, chocolates, cosmetics and the like.

Referring again to FIG. 12 in a next step, a second plug member 90 is seated within the side walls 76 of the mold cavity 86a and atop the moldable mixture 88. The second plug member 90 has a cross-sectional shape generally corresponding to the cross-sectional shape of the mold cavity 68a. Each of the first and second plug members 86, 90 and the moldable mixture 88 has a thickness. The total of the thicknesses of the second plug members 86, 90 and the moldable mixture 88 results in an upper face 92 of the second plug member 70 extending above the upper face 70 of the mold base 18. The loading process of mold cavity 68a is repeated for any desired quantity of mold cavities 68b-68e.

Referring again to FIG. 12, the loaded mold assembly 18 is placed in the framework 22 of the press apparatus 10 in a manner such that the lower face 72 of the mold base 18 seats against the top face 36 of the base plate 30. In a next step, the press plate 28 is moved in a vertical downward direction, as indicated by direction arrows D1, and into contact with the upper face 92 of the second plug member 90. The plate plate 24 continues movement in the downward vertical direction, thereby pushing the second plug member 90 against the moldable mixture 88 until such time that the moldable mixture 88 is squeezed into the volumetric shape formed by the combination of the mold cavity 68a, the first plug member 86 and the second plug member 90. The downward compression stemming from the press plate 28 continues until the moldable mixture 88 is forced into the volumetric shape of the mold cavity 68a. The press plate 28 is maintained in this position until the desired solidification of the moldable mixture occurs. In a next step, the loaded mold base 18, having the cured moldable mixtures is removed from the press assembly 16.

Referring now to FIGS. 13 and 14, a release assembly 96 is illustrated. As will be explained in more detail below, the release assembly 96 is configured for use with the press assembly 16 to dislodge the cured moldable mixture from the mold base 18. The release assembly 96 includes a base plate 98 and a plurality of spaced apart release fingers 100a-100e extending from the base plate 98. The spacing, size, cross-sectional shape and arrangement of the plurality of release fingers 100a-100e correspond to the spacing, size, cross-sectional shape and arrangement of the cavity apertures 82a-82e.

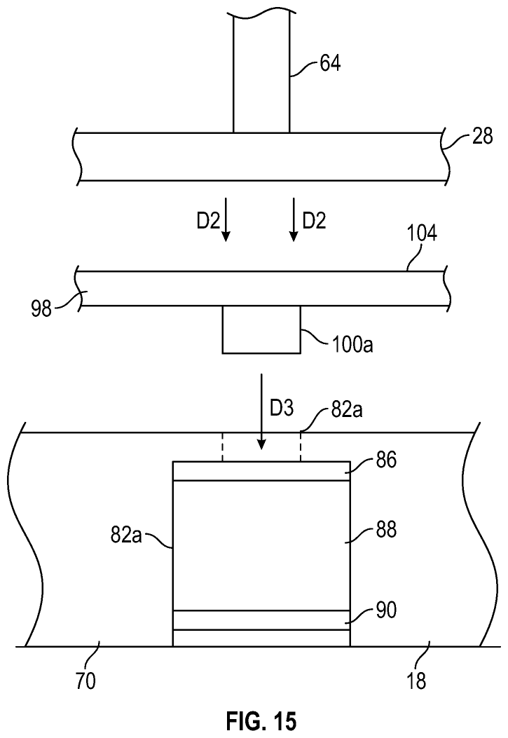

Referring now to FIG. 15, the method of using the press apparatus 10 to remove the cured moldable mixture will now be described. In a first removal step, the mold base 18, having the first plug member 86, the compressed and cured moldable mixture 88 and the second plug member 90 is inverted and placed in the framework 22 of the press assembly 16 in a manner such that the upper face 70 of the mold base 18 seats against the top face 36 of the base plate 30. In this position, the cavity aperture 82a faces the press plate 28. In a next step, the press plate 28 is moved in a vertical downward direction, as indicated by direction arrows D2, and into contact with a back face 104 of the base plate 98 of the release assembly 96. The press plate 28 continues to be moved in the downward vertical direction thereby pushing the release finger 100a through the cavity aperture 82a, as indicated by direction arrow D3, and into contact with the first plug member 90, until such time that the cured moldable mixture is urged from the cavities 82a.

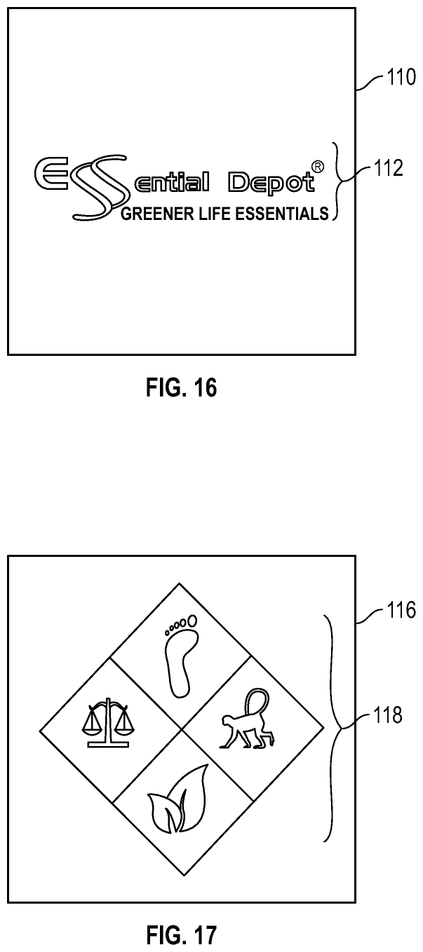

It is within the contemplation of the press apparatus 10 that the faces of the first and second plug members 86, 90 in contact with the moldable mixture 88 can have imprints, markings, projections and the like, configured to form corresponding imprints, markings and/or projections on faces of the cured moldable mixture 88. Referring now to FIG. 16, a first non-limiting example of a molded product 110 having an imprint or projection 112 is illustrated. Referring now to FIG. 17, a second non-limiting example of a molded product 116 having an imprint or projection 118 is illustrated. It should be appreciated that the imprints and/or projections can provide any desired artistic effect.

The apparatus and method for forming molded product provides many benefits, although all benefits may not be available in all embodiments. As a first benefit, the molded products can be produced in a fast, easy and efficient manner Second, more than one molded product can produced at a time. Third, the apparatus is portable. Fourth, the apparatus can be shipped. Fifth, a relatively small power source can be used to power the press assembly. Sixth, the production process is clean, meaning spillages are minimizes and cleanup efforts and times are also minimized. Finally, the molded products can have any desired size and cross-sectional shape.

In accordance with the provisions of the patent statutes, the principle and mode of the apparatus and method for forming molded products have been explained and illustrated in certain embodiments. However, it must be understood that the apparatus and method for forming molded products may be practiced otherwise than as specifically explained and illustrated without departing from its spirit or scope.

What is claimed is:

1. A press apparatus for forming molded products, comprising:
a motive source;
a press assembly in fluid communication with the motive source, the press assembly including a press plate configured for axial movement and a device configured to actuate axial movement of the press plate as initiated by the motive source;
a mold base positioned within the press assembly and configured for engagement with the press plate, the mold base including a plurality of mold cavities, each of the mold cavities including a mold cavity aperture, each of the mold cavity apertures arranged in a pattern and configured to provide access to a molded product positioned in a mold cavity; and
a release assembly is configured for engagement with the mold base and has a plurality of release fingers, each extending from a base plate, the plurality of release fingers arranged in a pattern that aligns with the pattern of the mold cavity apertures.

2. The press apparatus of claim 1, wherein the motive source is an air compressor.

3. The press apparatus of claim 1, wherein the press assembly includes a pneumatic cylinder assembly configured for fluid communication with the motive source.

4. The press apparatus of claim 3, wherein the press plate is connected to a piston rod extending from the pneumatic cylinder assembly.

5. The press apparatus of claim 1, wherein each of the mold cavity apertures is positioned in a bottom wall of the mold cavities.

6. The press apparatus of claim 1, wherein each of the release fingers has a spacing, size, cross-sectional shape and arrangement that correspond to the spacing, size, cross-sectional shape and arrangement of the cavity apertures.

7. The press apparatus of claim 5, wherein in a loaded arrangement, a first plug member is configured for seating on the bottom wall of each of the mold cavities and configured to prevent a mold mixture from exiting the cavity aperture.

8. The press apparatus of claim 7, wherein in a loaded arrangement, a moldable mixture is positioned atop the first plug member.

9. The press apparatus of claim 8, wherein in a loaded arrangement, a second plug member is position atop the moldable mixture.

10. The press apparatus of claim 1, wherein in a loaded arrangement, an upper face of the second plug member extends above an upper face of the mold base.

11. A method of using a press apparatus for forming molded products, the method comprising the steps of:
providing fluid communication between a motive source and a press assembly, the press assembly including a press plate configured for axial movement and a device configured to actuate axial movement of the press plate;
positioning a mold base within the press assembly in a manner such that the press plate aligns with the mold base;
actuating axial movement of the press plate and engaging the mold base, the mold base including a plurality of mold cavities;
compressing a moldable mixture positioned within a plurality of the mold cavities, thereby forming a plurality of molded products;
inverting the mold base and repositioning the inverted mold base within the press assembly and aligning with the press plate;
engaging the inverted mold base with a release assembly, thereby releasing the molded products from the mold base.

12. The method of claim 11, wherein the motive source is an air compressor.

13. The method of claim 11, wherein the press assembly includes a pneumatic cylinder assembly configured for fluid communication with the motive source.

14. The method of claim 11, including the step of connecting the press plate to the pneumatic cylinder assembly with a piston rod.

15. The method of claim 11, including the step of locating a mold cavity aperture in a bottom wall of each of the mold cavities.

16. The method of claim 15, wherein the release assembly includes a plurality of release fingers having a spacing, size, cross-sectional shape and arrangement that correspond to a spacing, size, cross-sectional shape and arrangement of the cavity apertures of the mold base.

17. The method of claim 15, including a first loading step of seating a first plug member on the bottom wall of each of the mold cavities, the first plug member configured to prevent a mold mixture from exiting the cavity aperture.

18. The method of claim 17, including a second loading step of positioning a moldable mixture atop each of the first plug members.

19. The method of claim 18, including a third loading step of seating a second plug member atop the moldable mixture.

20. The method of claim 19, wherein in a loaded arrangement, an upper face of the second plug member extends above an upper face of the mold base.
